(19) United States
(12) Patent Application Publication
(10) Pub. No.: US 2026/0085773 A1
(43) Pub. Date: Mar. 26, 2026

(54) EXPANDABLE HOSE

(71) Applicant: Aiqi ZHENG, Zhongshan (CN)

(72) Inventor: Aiqi ZHENG, Zhongshan (CN)

(21) Appl. No.: 19/184,984

(22) Filed: Apr. 21, 2025

Related U.S. Application Data
(60) Provisional application No. 63/699,458, filed on Sep. 26, 2024.

(51) Int. Cl. F16L 11/112; F16L 11/118

(52) U.S. Cl. CPC F16L 11/112; F16L 11/118

(57) ABSTRACT

An expandable hose having an outer layer and an inner duct is disclosed. The inner duct creates a fluid flow path between a first end and the second end of the expandable hose through each of a first connector and the second connector. The inner duct is constructed of a corrugated, flexible material to allow for expansion in response to increased fluid pressure in the expandable hose, which causes a lengthening of the expandable hose. The outer layer is not directly connected to the inner duct. The outer layer is made of a flexible material to allow for responsive expansion and contraction. Upon a decrease in fluid pressure, the outer layer contracts, which in turn causes the inner duct to contract in response.

### CROSS-REFERENCE TO RELATED APPLICATIONS

This application claims priority to U.S. provisional application No. 63/699,458, entitled “Expandable Hose,” filed Sep. 26, 2024, which is incorporated by reference herein in its entirety.

### FIELD OF THE INVENTION

The present invention relates to an expandable hose. The expandable hose an inner duct that expands and contracts in response to fluid pressure in the expandable hose.

### BACKGROUND

Current expandable hoses suffer from a variety of deficiencies. Typical expandable hoses, with prolonged use, suffer degradation of the elastic inner tube, resulting in reduced elasticity and increased susceptibility to rupture, thus shortening the expandable hose's lifespan. Additionally, the surface of latex or rubber-based elastic tubes is relatively soft, making them prone to punctures from external objects, further affecting their durability.

It is an object of the present invention therefore to address these, and other, various deficiencies of current expandable hoses.

### SUMMARY

Exemplary embodiments include an expandable hose including an inner duct made of a corrugated, flexible material; an outer layer made of an elastic material; a first end having a first connector that is a first termination point for the inner duct and the outer layer; and a second end having a second connector that is a second termination point for the inner duct and the outer layer; wherein the inner duct provides a fluid flow path between the first end and the second end through each of the first connector and the second connector and the corrugated, flexible material of the inner duct is configured to allow for expansion of the inner duct in response to an increase in fluid pressure in the inner duct; and wherein the outer layer is configured to elongate in response to the expansion of the inner duct and the outer layer is further configured to contract upon a decrease in fluid pressure, causing the inner duct to contract in response.

Another exemplary embodiment includes an expandable hose including an inner duct made of a corrugated, flexible material; an outer layer made of an elastic material; a first end having a first connector that is a first termination point for the inner duct and the outer layer, the first end further including a valve located between the first connector and the first termination point; and a second end having a second connector that is a second termination point for the inner duct and the outer layer; wherein the inner duct provides a fluid flow path between the first end and the second end through each of the first connector and the second connector and the corrugated, flexible material of the inner duct is configured to allow for expansion of the inner duct in response to an increase in fluid pressure in the inner duct; and wherein the outer layer is configured to elongate in response to the expansion of the inner duct and the outer layer is further configured to contract upon a decrease in fluid pressure, causing the inner duct to contract in response.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1A depicts a perspective view of an expandable hose according to exemplary embodiments.

FIG. 1B depicts a perspective view of a second expandable hose according to exemplary embodiments.

FIG. 1C depicts a perspective view of a third expandable hose according to exemplary embodiments.

FIG. 2A depicts a cross-sectional view of the expandable hose according to exemplary embodiments with the inner duct in a relaxed state.

FIG. 2B depicts a cross-sectional view of the second expandable hose according to exemplary embodiments with the inner duct in a relaxed state.

FIG. 2C depicts a second cross-sectional view of the second expandable hose according to exemplary embodiments with the inner duct in a relaxed state.

FIG. 3 depicts a cross-sectional view of the expandable hose according to exemplary embodiments with the inner duct in an expanded state.

FIG. 4 depicts a magnified cross-sectional view of a connection coupler according to exemplary embodiments with the inner duct in a relaxed state.

FIG. 5 depicts a magnified cross-sectional view of the connection coupler according to exemplary embodiments with the inner duct in an expanded state.

FIG. 6 depicts a magnified cross-sectional view of a second connector according to exemplary embodiments with the inner duct in a relaxed state.

FIG. 7 depicts a magnified cross-sectional view of the second connector according to exemplary embodiments with the inner duct in an expanded state.

FIG. 8 depicts a magnified cross-sectional view of a first connector according to exemplary embodiments with the inner duct in a relaxed state.

FIG. 9 depicts a magnified cross-sectional view of the first connector according to exemplary embodiments with the inner duct in an expanded state.

FIGS. 10A and 10B are end on views of the expandable hose according to exemplary embodiments.

FIG. 11A depicts a side view of the third expandable hose according to exemplary embodiments.

FIG. 11B depicts a cross-sectional view of the third expandable hose according to exemplary embodiments with the inner duct in a relaxed state.

FIG. 11C depicts a second cross-sectional view of the third expandable hose according to exemplary embodiments with the inner duct in an expanded state.

FIGS. 11D, 11E, and 11F depict end on views of the third expandable hose according to exemplary embodiments.

FIG. 12A depicts a perspective view of an expandable hose according to exemplary embodiments.

FIG. 12B depicts a cross-sectional view of the expandable hose according to exemplary embodiments with the inner duct in a relaxed state.

FIG. 12C depicts an end view of the expandable hose according to exemplary embodiments

FIG. 12D depicts a cross-sectional view of the expandable hose according to exemplary embodiments with the inner duct in an expanded state.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

Current expandable hoses are typically composed of an elastic inner tube and an outer protective sheath. The inner tube is typically made from materials such as latex, rubber, or TPR (thermoplastic elastomer). Due to its high elasticity, when connected to water pressure ranging from 3 to 10 bars, the inner tube can expand both radially and longitudinally. Under the protection of the outer tube, the hose's internal water passage and length can expand by 2 to 4 times. When the water pressure is turned off, the hose quickly releases any remaining water and retracts back to its original size due to the elastic rebound of the inner tube. With repeated use, degradation results in the hose, leading to reduced life span of the hose as well as susceptibility to punctures and ruptures.

Exemplary embodiments include a corrugated inner duct, or inner tube, within an outer layer. The inner duct is made from flexible material that may include non-plastic or plastic materials or combinations thereof (such as, but not limited to, PVC (polyvinyl chloride), PU (polyurethane), plastic reinforced with steel wire, combinations thereof, or similar materials). The inner duct may be constructed with a corrugated profile with a series of continuous peaks and valleys, allowing the duct to compress and extend without permanent deformation (i.e., like an accordion). Compared to traditional materials, such as those in typical hoses, this new material offers higher strength and better resistance to aging, while also meeting higher hygiene standards, allowing it to be manufactured to drinking water-grade quality. In some embodiments, a protective sheath may be included around the inner duct to provide protection to the inner duct material and may assist with the contraction of the inner duct. The sheath may be made of a flexible and elastic material, such as, but not limited to, rubber, latex, combinations thereof, or other similar materials. The sheath may be attached to or wrapped around the inner duct such that it expands and contracts with the inner duct. While water is used as an example herein, the hose may be used with other fluids. Of course, it should be appreciated that the hose 100 would need to be made of appropriate materials to handle fluids other than water if required based on the fluid properties.

The outer layer, or outer tube, is made from an elastic material, such as, but not limited to, elastic fabric or textile fibers (such as, but not limited to, polyester, nylon, or cotton), synthetic rubber (such as, but not limited to, spandex, nitrile rubber, etc.), natural rubber, combinations thereof, or similar materials. The outer layer can return to its original length after being stretched. The outer layer may have a roughened surface or raise textured on its exterior to provide wear protection during use of the hose (e.g., to help prevent damage from dragging the hose over rough ground or objects. The outer layer may be separate from (i.e., not attached to) the inner duct and/or sheath.

When subjected to water pressure, the corrugated inner duct, initially in a folded state, expands (along with the elastic protective sheath, if present) and the elastic outer layer expands (elongates) also in response. When the water source is turned off, the elastic outer layer contracts towards its relaxed state due to its elasticity, thereby enabling the hose to contract effectively. In response to this outer layer contraction, the inner duct contracts to its relaxed state (along with the elastic protective sheath, if present, which due to its elasticity assists with the contraction of the inner duct).

Additionally, in exemplary embodiments, there may be a connection between both ends of the inner tube and the outer sheath to enhance stability of the hose, particularly in longer length hoses. This design ensures that the inner and outer components remain securely joined, thereby enhancing the overall structural integrity and performance of the hose during use. In various embodiments, this connection component can be designed with a reflective feature to enhances visibility in low-light conditions, promoting safety for both users and bystanders. The connection component, in various embodiments, is a plastic sheath or joiner assembly located at one or more positions along the hose length. The connection component may be located at a midpoint of the hose length. Certain embodiments may have multiple connection components. For example, the expandable hose may have two or more connection components. In various embodiments, the connection component may placed at intervals of 25 feet. For example, a 50 foot hose may have a connection component located at is midpoint. Other spacing intervals may be used. In some embodiments, there is no connection or coupling between the inner duct and the outer layer. That is, the expandable hose may lack the connection component.

The expandable hose of exemplary embodiments can be constructed in a variety of lengths and diameters with a circular cross-section. For example, the hose diameter may be ⅝ inch. Other diameters such as ½ inch, ¾ inch, and 1 inch may be used. Metric sizes may also be used. The hose length may be measured in its fully expanded state or in its relaxed state. In some embodiments, a non-circular cross-section may be used.

The ends of the hose include a first connector and a second connector. These connectors are located at the terminal ends of the hose. The first connector may be a male connector and the second connector may be a female connector. In some embodiments, the first and second connector may be the same. For example, the first and second connector may both be female or male connectors. The first and second connectors may be made of plastic, metal, or combinations thereof. The first and second connector may be of various sizes to fulfill the connection needs of the end user.

The first and second connector may conform to various standards. In exemplary embodiments, the expandable hose may conform to applicable standards and connection sizing (e.g., thread type and size) for the area in which is it primarily used. For example, the first and second connector may have thread size to fit a ¾ inch connection such as a ANSI standard ¾ inch—11.5 NH (American Standard Hose Coupling Threads for Full Form) or NHR (American Standard Hose Coupling Threads for Garden Hose Applications) thread size. Other thread sizes and types may be used such as ⅝ inch and/or GHT (Garden Hose Thread). In various embodiments, metric sizes and standard thread types may be used.

The first connector serves as a termination point for one end of the inner duct and the outer layer. It contains a through-hole, channel, or fluid path that allows fluid (e.g., water) to exit (in exemplary embodiments) the inner duct from the first connector.

The second connector serves as a termination point for the other end of the inner duct and the outer layer. It also contains a through-hole, channel, or fluid path, allowing fluid (e.g., water) to enter (in exemplary embodiments) the inner duct from the second connector.

According to exemplary embodiments, the first connector may serve as the outlet to the hose and the second connector may serve as the inlet. In various embodiments, the first and second connector may swap as to which is the inlet and which is the outlet (i.e., the first connector may serve as the inlet and the second connector may serve as the outlet).

In various embodiments, the first and/or second connector may include a valve to open or close the fluid path through the connector. In exemplary embodiments, the valve may be a ball valve. For example, in an embodiment where the second connector is a female connection, it allows for connection of the expandable hose to a fluid source (e.g., a hose bib or other fluid source connection) using this connector; the first connector is a male connection and has a valve located inward of the end connector on the hose. The valve may be used to control fluid flow through the hose. Using the valve, the fluid may be contained within the hose, allowing it to be positioned for use and/or a nozzle or other attachment put onto the first connector. The fluid flow through the hose and out the first connector can then be enabled by actuating the valve proximal the first connector. However, other configurations may be used. As noted above, the first and second connectors may be reversed in function (i.e., inlet and outlet swapped and location of the valve on the hose swapped).

When the fluid flow through the hose (i.e., flowing out of) is restricted, the pressure inside the inner duct increases, causing the inner duct to expand, and the outer layer extends (elongates) along with it causing the hose to extend in length. Once the fluid pressure decreases, or is released (e.g., by opening valve, the outer layer will contract and return to its original, relaxed state and in response the inner duct will contract to its relaxed state. For example, as in the configuration described above, when the valve is closed off (such as by using the internal valve or through a nozzle or other attachment to the male threaded end), the fluid flow is restricted causing the internal fluid pressure in the hose (i.e., within the inner duct) to increase and as a result, the inner duct expands, and outer layer elongates in response causing the hose to expand in length. It should be appreciated that the flow through the hose may also be restricted by a flow restrictor, such as, a nozzle or other attachment coupled to one of the connectors of the expandable hose (this may be in addition to the valve in the hose). Alternatively, the fluid source (e.g., hose bib) may be turned off to cease fluid flow at the source (i.e., no fluid entering the hose at the second connector).

This design according to exemplary embodiments improves the durability, strength, and hygiene of the hose, making it suitable for potable water applications and enhancing its overall lifespan.

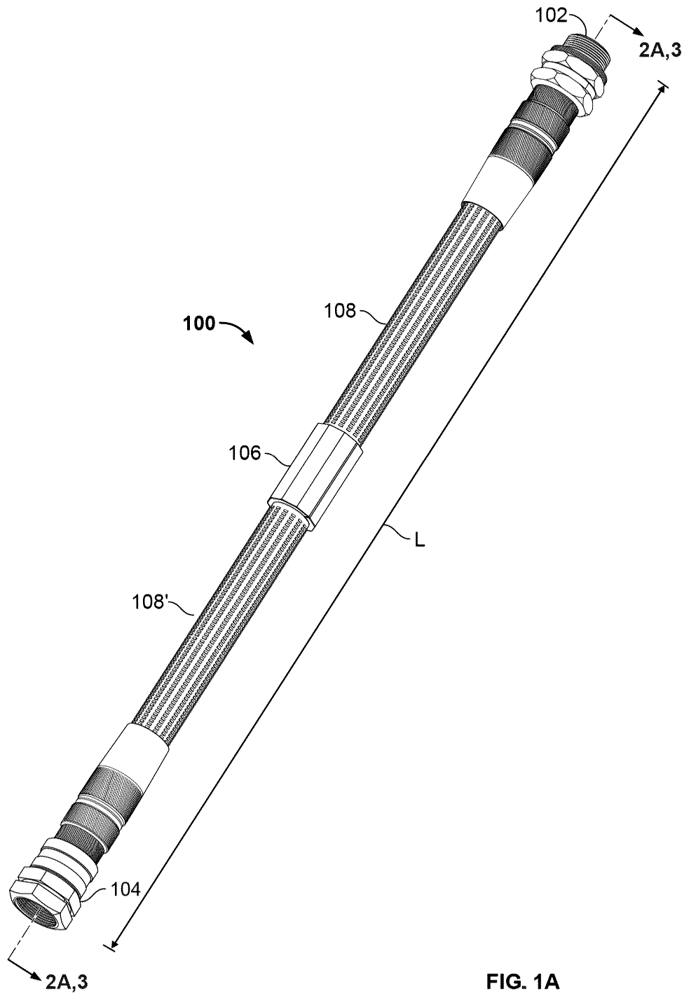

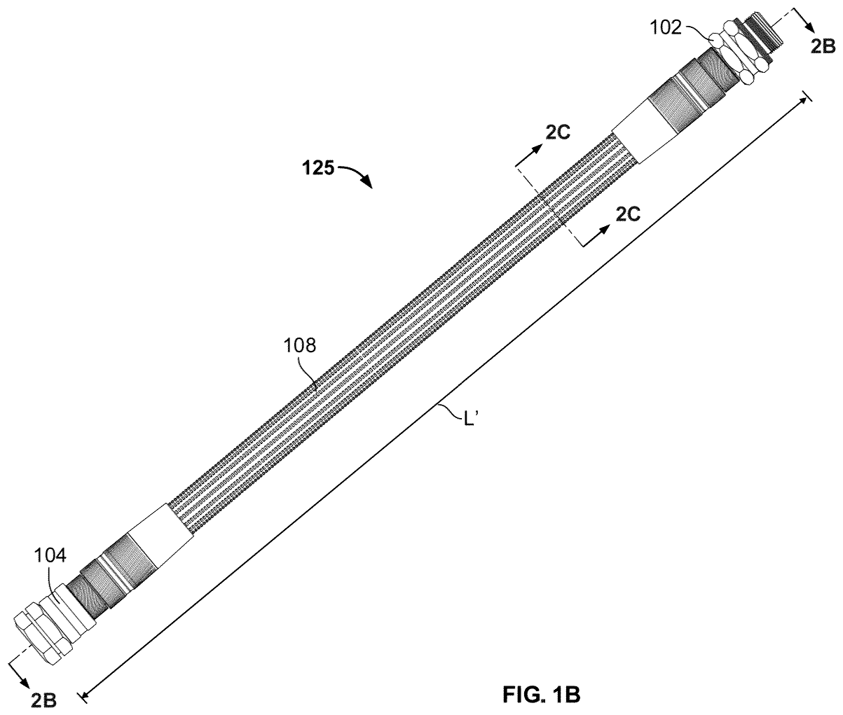

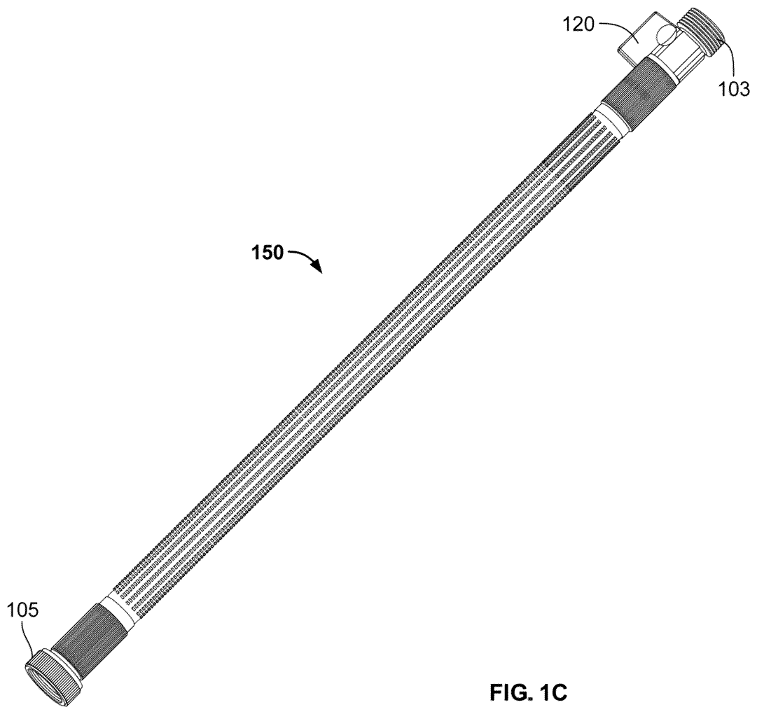

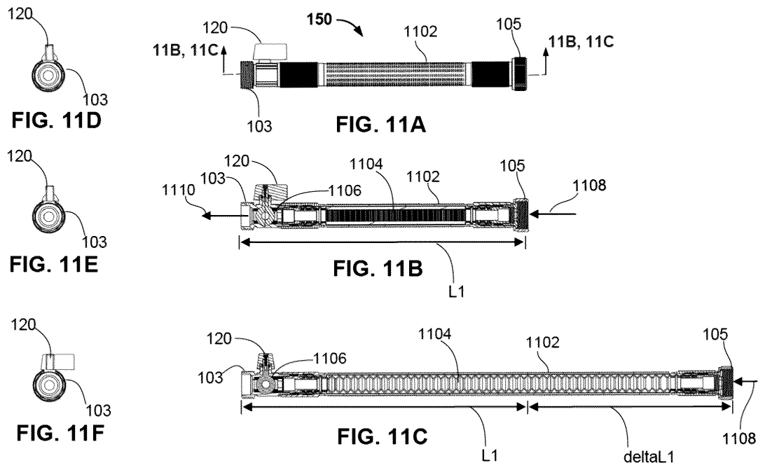

FIG. 1A depicts a perspective view of an expandable hose 100 according to exemplary embodiments. The expandable hose 100 has a length L (which is the length of the expandable hose in its unused state or resting state (e.g., this is the length when the hose is bought off the shelf)), that may be measured from a first connector 102 to a second connector 104. The expandable hose 100 may be of various lengths (e.g., 25 ft, 50 ft, 100 ft, etc.) and may be of different diameters (e.g., ½ inch, ⅝ inch, ¾ inch, 1 inch, etc.). The connection sizes may also be of different types as described above (e.g., ¾ inch ANSI standard garden hose, etc.). In various embodiments, metric lengths, diameters, and connection sizes may be used. It should be understood that this is an exemplary view and could be a view of the expandable hose in either the unexpanded or expanded state, since the difference, at least externally in those two states is in the overall length of the hose (which would change from L to L+delta L (i.e., the change in length due to expansion of the hose), with some difference in external appearance. For example, the outer layer may appear to grow smoother as it stretches and elongates. In some embodiments, the outer layer may have an appearance that remains essentially the same (visually) as it elongates and contracts, with the change being in length. As described below, internally, the inner duct expands and contracts depending on the state of the expandable hose. An example of the change in length as described above is depicted in FIG. 11A, B, and C, described below. These illustrations of the elongation are applicable to the various embodiments described herein.

The change in length may be from 1.2 to 4 times. According to exemplary embodiments, the change in length may be in the range of approximately 1.8 to 2.5 times.

The expandable hose 100 has a first connector 102 at one end and a second connector 104 at the opposite end. It can be seen in FIG. 1A, the first connector 102 is a male connector and the second connector 104 is a female connector. Thus, as would be appreciated by one of ordinary skill in the art, the second connector 104 would be coupled to a hose bib and water (for example) would enter the expandable hose at the second connector 104. The first connector 102 could be left unattached or have an attachment, such as a nozzle, screwed thereon. In either configuration, the first connector 102 serves as the exit point for the water.

In various embodiments, the type of connector (male vs. female) may be reversed with respect to the first and second connectors and, in some embodiments, the first and second connectors may be the same (i.e., both male or both female). The expandable hose 100 may have a connection component 106 located at a point along its length. In various embodiments, there may be multiple connection components. In certain embodiments, as described herein, the connection component 106 may not be present. The expandable hose 100 has an outer layer 108 and 108′ (to designate the different outer layers on either side of the connection component 106; but otherwise 108/108′ are the same). The outer layer, or outer tube, may be made from flexible and elastic materials that include elastic fabric or textile fibers (such as, but not limited to, polyester, nylon, cotton, combinations thereof, or similar materials) or synthetic rubber (such as, but not limited to, spandex, nitrile rubber, etc.) or natural rubber, or combinations thereof, or similar materials. The surface of the outer layer may have a texture or other surface features, such as shown in FIG. 1A. This texture may provide protection to the hose from abrasions, etc. when in use and moved or dragged over rough objects.

FIG. 1B depicts an expandable hose 125 according to exemplary embodiments. The expandable hose 125 may have the same basic external and internal structure as the expandable hose 100. The expandable hose 100 has a length L′ (in the relaxed state, with L′ increasing to L′+delta L′ when pressurized as with the expandable hose 100). However, as can be seen, the expandable hose 125 lacks a connection component 106 (and hence has a continuous outer layer 108).

FIG. 1C depicts an expandable hose 150 according to exemplary embodiments. The expandable hose 150 may have the same internal and external structure as the expandable hose 125 of FIG. 1B, except as described below regarding the end connection structure. As depicted, the expandable hose 150 lacks the connection component 106 (like that of the expandable hose 125). However, the connection component may be included in some embodiments and in which case the structure would be same as that of the expandable hose 100.

The expandable hose 150 has a valve handle 120 proximal to or as part of a first connector 103. The valve handle 120 may attached to a ball valve (located internally) actuated by the handle. The valve is located inward of the first connector 103 internal to the expandable hose. The ball valve may allow for control of fluid flow through the expandable hose 150. The valve handle 120 allows for control of the internal valve position. For example, the valve handle 120, as depicted in FIG. 1C is in the open position that allows fluid flow therethrough. The handle can be rotated 90 degrees to close the valve completely and block fluid flow. The handle can also be rotated less than 90 degrees to partially block fluid flow (i.e., allow partial flow through the valve). Other types of valves and handles may be used. Additionally, in some embodiments both ends may have a valve. In various embodiments, a flow restrictor device having a valve may be coupled to the expandable hose. In various embodiments, this valve structure may be used on hoses 100 and 125 of FIGS. 1A and 1B. The expandable hose 150 has a second connector 105. This second connector 105 may be similar to the second connector 104, described above.

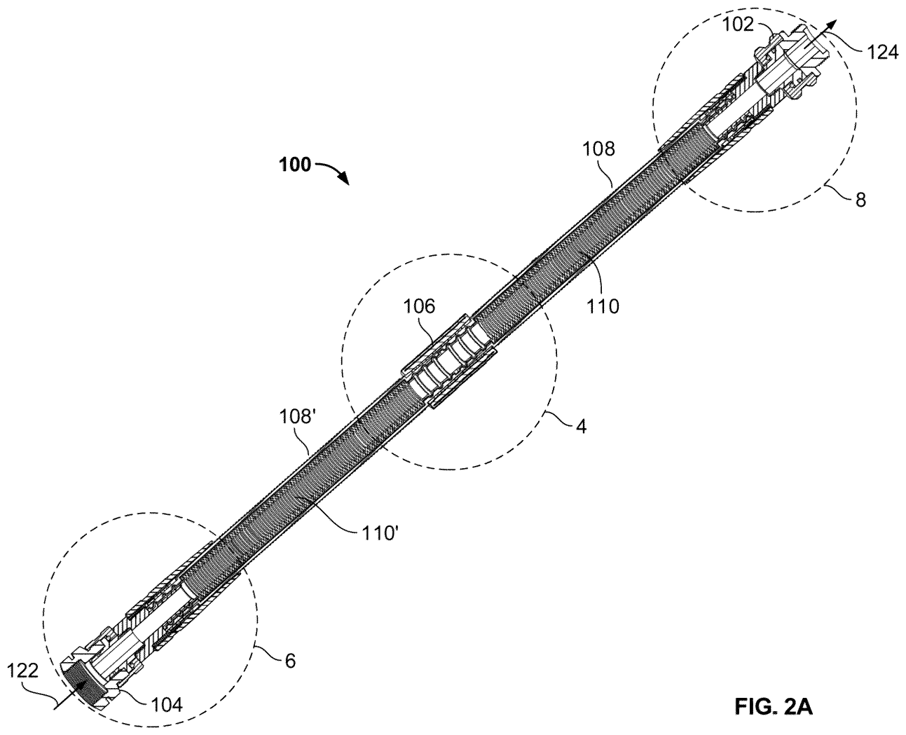

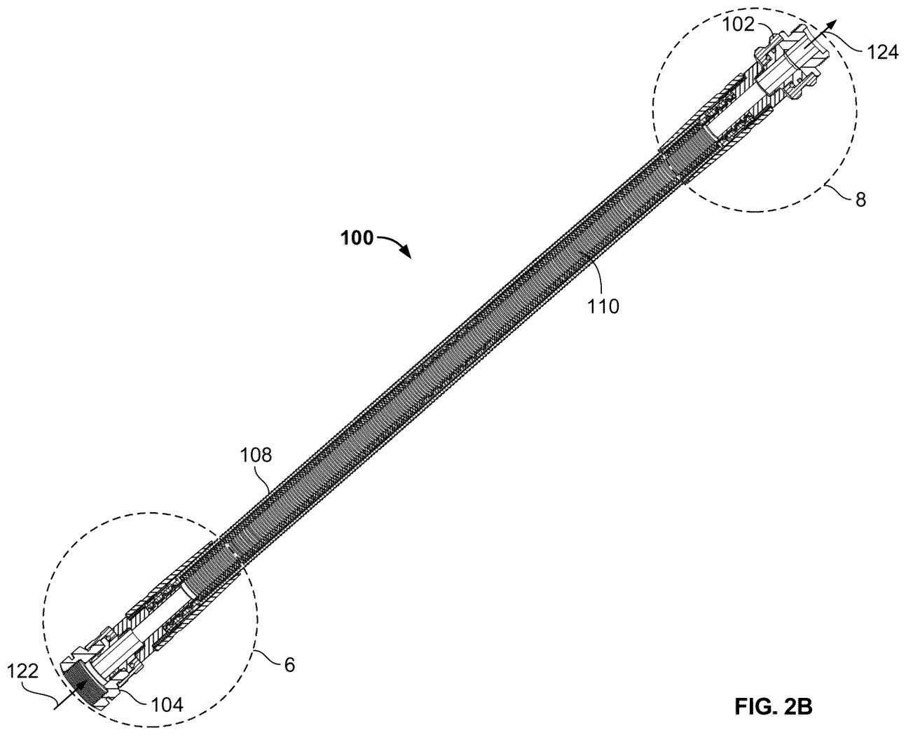

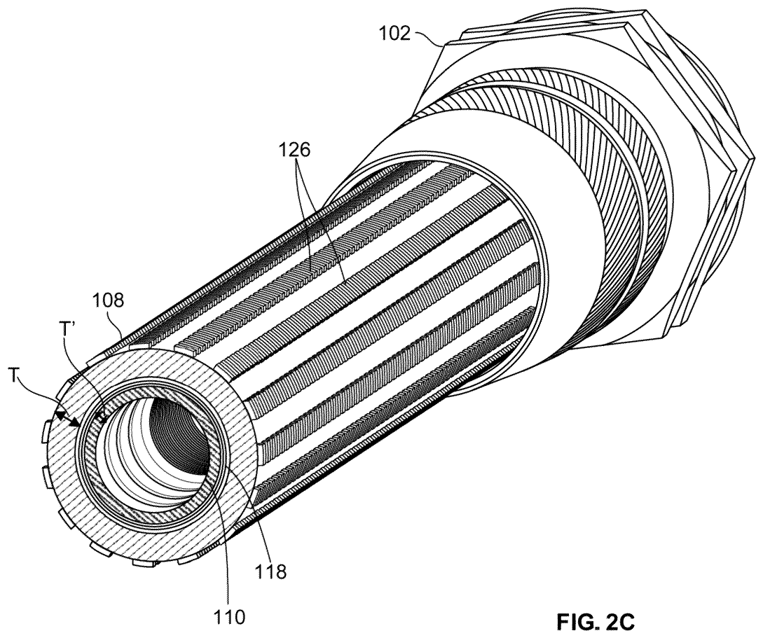

In FIG. 2A, a cross-sectional view of the expandable hose 100 is shown. Visible in this Figure is the inner duct 110 and 110′, as well as the outer layers 108 and 108′ (to designate the sections on either side of the connection component 106). It should be appreciated that inner duct 110/110′ are the same except for location on either side of the connection component 106. The inner duct 110 and 110′ is depicted in a contracted or relaxed state. The inner duct 110 and 110′ may be made from flexible material that may include non-plastic or plastic materials or combinations thereof (such as, but not limited to, PVC (polyvinyl chloride), PU (polyurethane), or plastic reinforced with steel wire or combinations thereof) or similar materials. As noted above, the inner duct may be constructed with a corrugated profile with continuous peaks and valleys, allowing the duct to compress and extend without permanent deformation (that is, allowing for expansion and contraction) (e.g., like an accordion or similar structure). Correspondingly, in FIG. 2A, the outer layer 108 and 108′ is in a normal or unstretched state. Here, it can be seen that the first and second connectors 102 and 104 serve as termination and anchor points for the outer layer and the inner duct. Further, it can be seen that the connection component joins the outer layer and the inner duct, serving as termination points for the outer layer and inner duct at a point along the length of the expandable hose. The direction 122 shows an exemplary fluid flow direction through the second connector 104 towards the first connector 102 to exit at the direction 124.

In FIG. 2B, a cross-sectional view of the expandable hose 125 is shown. It should be appreciated that the cross section of the expandable hose 125 is the same as that of the expandable hose 100 depicted in FIG. 2A, but without the connection component 106 (and thus having only outer layer 108 and inner duct 110 since there is not connection component 106 to separate those structures into sections as described above in FIG. 2A). Like in FIG. 2A, the direction 122 shows an exemplary fluid flow direction through the second connector 104 towards the first connector 102 to exit at the direction 124.

This cross-section view would be the same for the expandable hose 150, with the exception of differences in the connectors.

In FIG. 2C, a cross-sectional view of the expandable hose 125 is shown from a different angle to show the interior structure. This structure is the same for the expandable hoses 100 and 150. The outer layer 108 and the inner duct 110 can be seen. The outer layer 108 may have a thickness T and the inner duct 110 can have thickness T'. The thickness of the inner duct may be less than that of the outer layer. In various embodiments, as depicted in FIG. 2C, a protective sheath 118 may be included around the inner duct 110 to provide protection to the inner duct material. The protective sheath 118 may be connected to or coupled with the inner duct 110 over the length of the inner duct. That is, the protective sheath is structured in a way in that it may expand and contract with the movement of the inner duct 110. The inner duct 110 (and its protective sheath 118, if present) may not ne physically joined to the outer layer 108. The protective sheath may be made of latex, rubber, combinations thereof, or similar materials. It should also be appreciated that there may be a change in the overall diameter (i.e., an increase) of the expandable hose in response to an increase in fluid pressure in the inner duct (i.e., the fluid channel of the expandable hose). It should be appreciated that the protective sheath is present in FIGS. 2A and 2B (as well as the various enlarged figures shown therefrom), but is best (and labelled) in FIG. 2C.

In various embodiments, the outer layer 108 may have roughen or textured outer surface. For example, the outer layer may have a series of ridges 126 that run axially along the length of the expandable hose. This surface may provide protection to the outer layer 108 of the expandable hose to increase durability. Because the ridges 126 run axially, the ridges can expand and contract with the elastic outer layer during operation of the expandable hose.

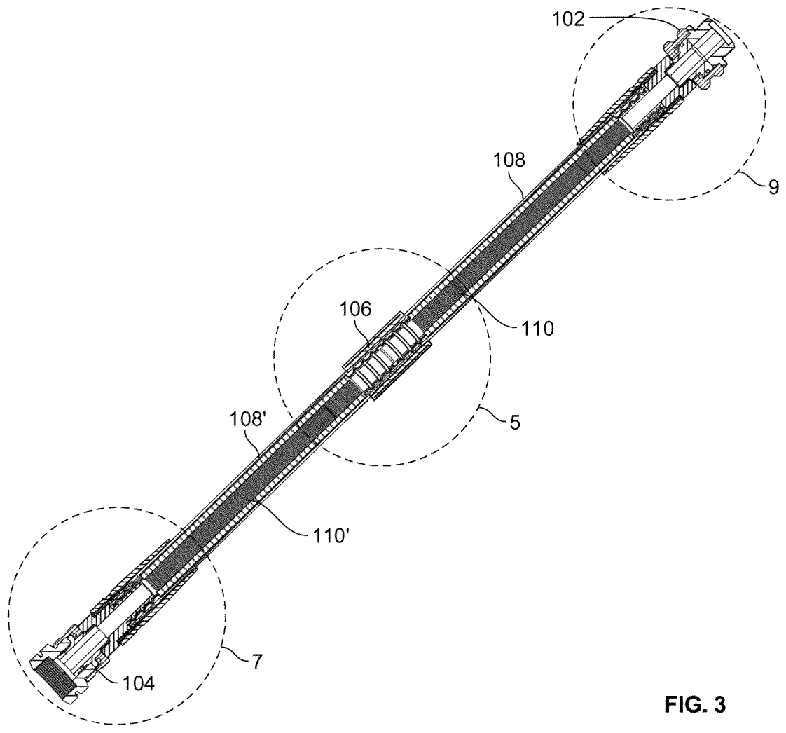

In FIG. 3, a second cross-sectional view is shown. In this view, the inner duct 110 and 110′ is in an expanded state. Correspondingly, the outer layer 108 and 108′ is stretched.

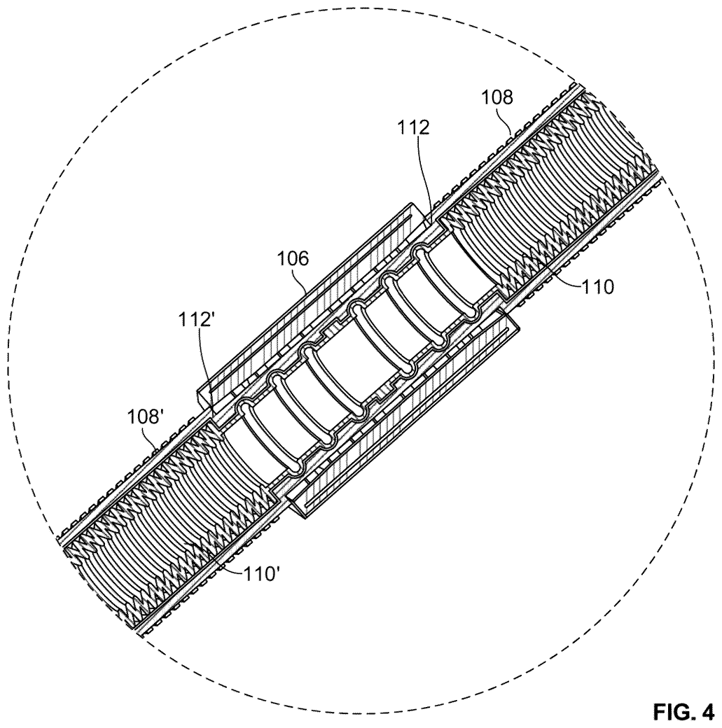

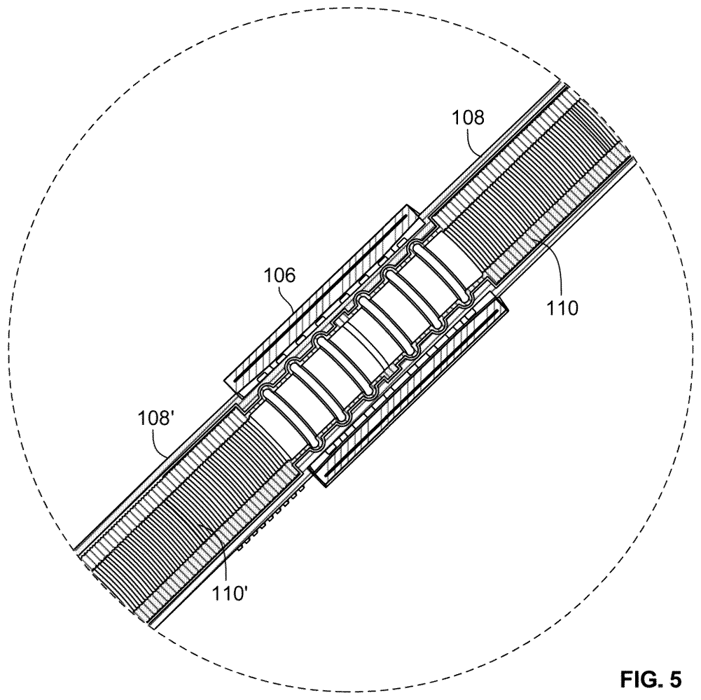

FIGS. 4-9 depict enlarged cross-sectional views of different part of the expandable hose according to exemplary embodiments (e.g., the expandable hose 100) in both relaxed and expanded states. For example, FIGS. 4, 6, 8 depict the inner duct in a relaxed state while FIGS. 5, 7, 9 are of the same enlarged cross sectional areas, but depict the inner duct, and, correspondingly, the outer layer, in an expanded state.

FIGS. 4 and 5 depict an enlarged cross-sectional view of a connection component 106 according to exemplary embodiments with the inner duct 110 and 110′ in a relaxed and in an expanded state. At 112 and 112′ the joining of and termination of the inner duct and outer layer on either side of the connection component 106 can be seen in FIG. 4, for example.

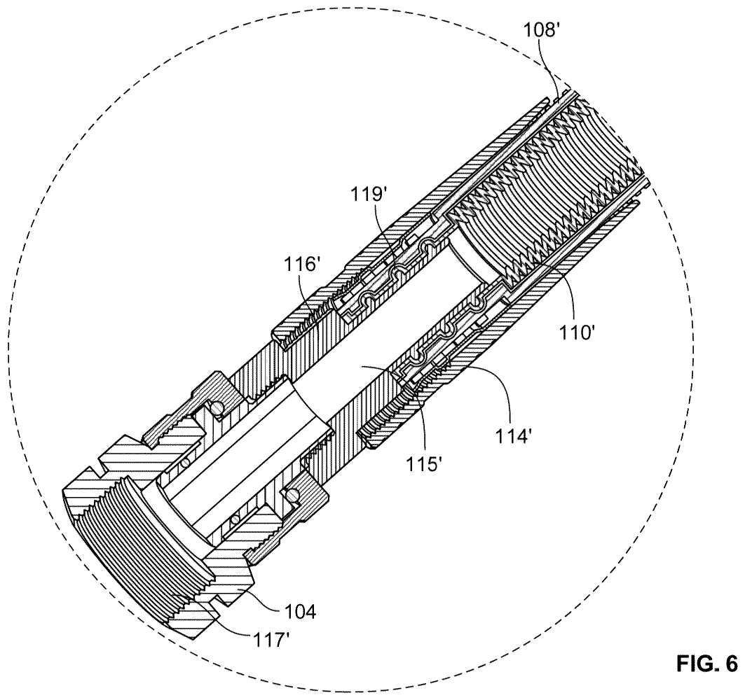

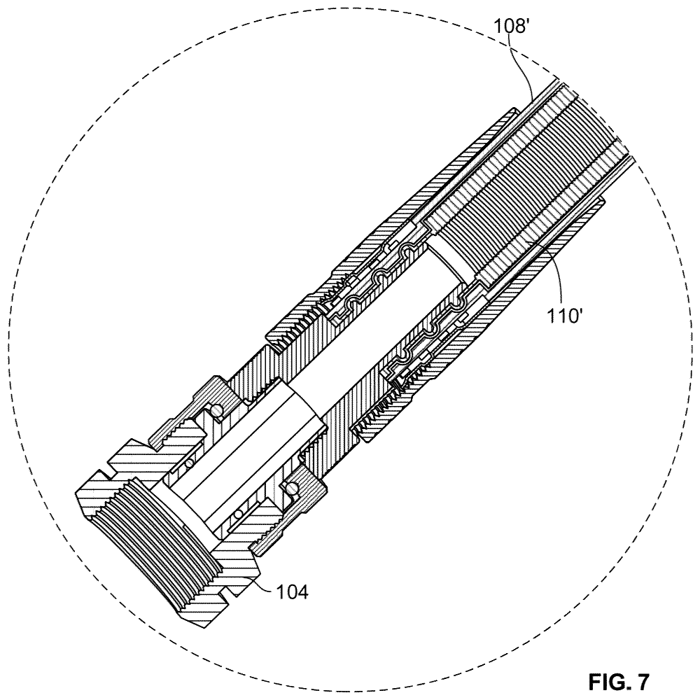

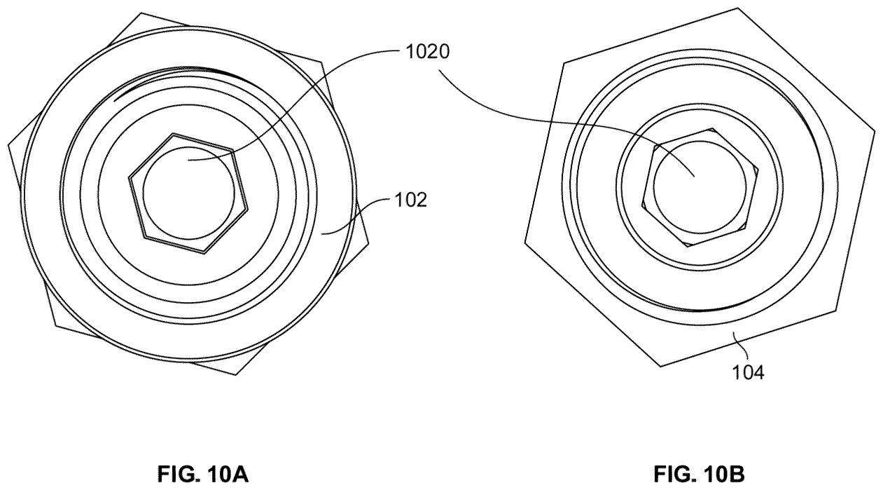

FIGS. 6 and 7 depict an enlarged cross-sectional view of a second connector according to exemplary embodiments with the inner duct 110′ in a relaxed state and an expanded state. An outer sheath 114′ may extend back along the hose length from the connection 104. The joining of and termination of the inner duct and outer layer can be seen in FIG. 6, for example. The second connector 104 includes a tubular spout 116′ that extends into the interior of the inner duct 110′ and the outer layer 108′ (and the protective sheath, if present). The spout 116′ is hollow and provides an extension 115′ of the interior fluid channel (1020, as labeled FIGS. 10A and 10B) from the inner duct into the connector. The outer layer 108′ and the inner duct 110′ overlap around the outside of this tubular spout and a series of ridges 119′ provide for effective securement. The outer sheath 114′ provides securing component which fits over this termination of the outer layer and the inner tube and compresses (or otherwise secures) these components onto the spout, as can be seen in FIG. 6, for example. These elements are thereby coupled to the second connector and terminate in the female threaded connector 117′ at the end of the expandable hose.

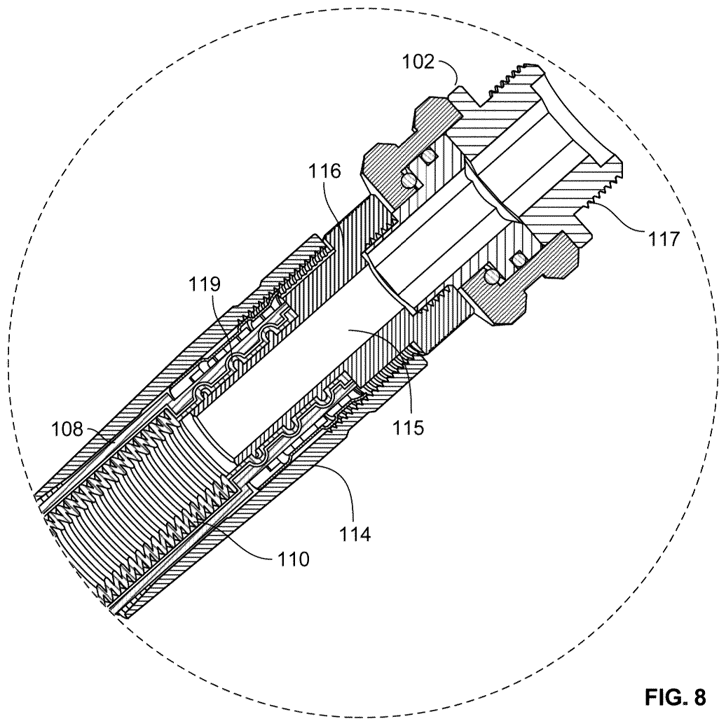

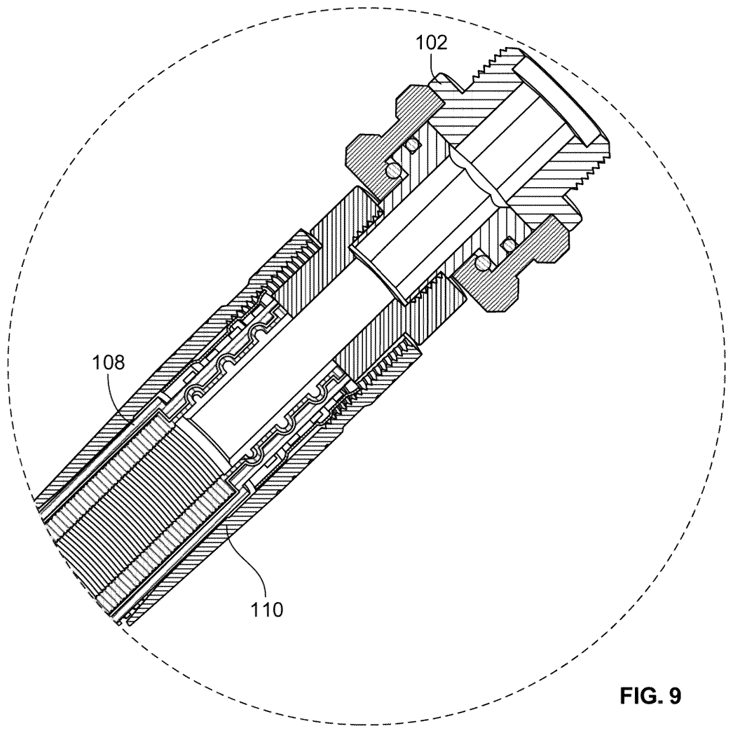

FIGS. 8 and 9 depict an enlarged cross-sectional view of a first connector 102 according to exemplary embodiments with the inner duct 110 in a relaxed state and an expanded state. An outer sheath 114 may extend back along the hose length from the connection 102. The joining of and termination of the inner duct and outer layer can be seen in FIG. 8, for example. The first connector 102 includes a tubular spout 116 that extends into the interior of the inner duct 110 and the outer layer 108 (and the protective sheath, if present). The spout 116 is hollow and provides an extension 115 of the interior fluid channel (1020, as labeled FIGS. 10A and 10B) from the inner duct into the connector. The outer layer 108 and the inner duct 110 overlap around the outside of this tubular spout and a series of ridges 119 provide for effective securement. The outer sheath 114 provides securing component which fits over this termination of the outer layer and the inner tube and compresses (or otherwise secures) these components onto the spout, as can be seen in FIG. 8, for example. These elements are thereby coupled to the first connector and terminate in the male threaded connector 117 at the end of the expandable hose.

It should be appreciated that as described above, the outer layer 108 and 108′ contracts and stretches with the inner duct 110 and 110′ (i.e., between a relaxed (or contracted) and extended (or expanded) state). As can be seen in the images, the outer layer's shape does not change appreciably in between these states, although some smoothing of this outer layer may be visible as it stretches (elongates) in response to the expansion of the inner duct. But overall, the expandable hose retains its basic external appearance in these different states. The outer layer then contracts upon a decrease in fluid pressure and returns to its relaxed state.

As shown in FIGS. 2A and 2B, the cross section of the first and second connectors (102, 104) may be the same (that is the enlarged cross sectional views of FIGS. 6, 8 are the same; the views of FIGS. 7 and 9 would also pertain to the expandable hose 125, 150 also). This structure may be similar to that of FIG. 1C also, with the first connector having a valve, for example.

FIGS. 10A and 10B are end on perspective views (of the first and second connectors (102, 104), respectively, of the expandable hose according to exemplary embodiments. The fluid path or channel 1020 through the expandable hose can be seen from the perspective of the first connector 102 and the second connector 104 (i.e., it runs from end to end to allow for fluid flow). The fluid channel runs through the inner duct (stated differently, the inner duct forms the fluid channel through the expandable hose). These end views would be applicable to the various embodiments described herein, with differences being in the connection type. However, each embodiment has a fluid path or channel through it for fluid flow.

FIG. 11A depicts a side view of the expandable hose 150 of FIG. 1C. The expandable hose 150 has a first connector 103 and a second connector 105 and a valve handle 120. The expandable hose has an outer layer 1102 and an inner duct 1104. The outer layer 1102 and the inner duct 1104 may be constructed as described above for the various embodiments. The expandable hose 150 has an exemplary fluid flow path with fluid entering at 1108 and exiting at 1110. In this example, the second connector 105 may be connected to a fluid source, such as a hose bib. The first connector 103 may be connected to a nozzle or other device for spraying the fluid; the first connector 103 may be free and not connected to any other device. The connectors may be constructed as described above with respect to the various embodiments.

The valve handle 120 is connected to a valve 1106 actuated by the handle as depicted. The valve 1106 allows for the control of fluid flow through the expandable hose 150. For example, the valve handle 120, as depicted in FIGS. 11A and 11B (as well as FIGS. 11D and 11E) is in the open position that allows fluid flow therethrough in the direction of the arrows 1108 and 1110 (that is, the valve 1106 is in the open position). The handle can be rotated 90 degrees to close the valve 1106 completely and block fluid flow which is depicted in FIG. 11C (as well as FIG. 11F). The handle can also be rotated less than 90 degrees to partially block fluid flow (i.e., allow partial flow through the valve). In exemplary embodiments, the valve 1106 may be a ball valve. Other types of valves and handles may be used.

As depicted in FIG. 11B, the expandable hose 150 has a length L1 which is the length of the expandable hose in its unused state or resting state (e.g., this is the length when the hose is bought off the shelf). The inner duct 1104 may be in the relaxed state. As depicted in FIG. 11C, with the valve 1106 in the closed position, the expandable hose may be under pressure and elongated to a length of L1+deltaL1. The inner duct 1104 may be in the expanded state. The outer layer 1102 may also expand (elongate) in response the change in the inner duct 1104. Once pressure is reduced in the expandable hose, the inner duct 1104 may contract and the expandable hose will decrease in length (i.e., deltaL1 will decrease) until eventually the expandable hose will return to length L1. It should be appreciated that when the expandable hose 150 is connected to a fluid source (e.g., a hose bib) and fluid pressure is applied to the expandable hose (e.g., the hose bib is turned on to allow for fluid flow into the expandable hose) and the valve 1106 is in the open position (e.g., as depicted in FIGS. 11A and 11B), the inner duct 1104 may expand due to the increase in fluid pressure caused by the fluid flow into the hose. The expansion may be to a point less than delta L1 but still enough to cause a lengthening of the length (i.e., greater than L1). Further, if the valve 1106 is throttled (e.g., closed slightly), this will cause the inner duct 1104 to expand, potentially up to the full deltaL1, based on the increase in pressure. Additionally, when opening the valve 1106 from a closed state with fluid pressure, the inner duct 1104 may remain in an expanded state during use of the expandable hose 150. In various embodiments, the valve may be a part of other flow restrictors, such as hose nozzles, sprayers, etc. That is, the valve may be located external to the hose on a coupled flow restrictor or there may be a valve in the expandable hose as described as well as another valve on a flow restrictor attached to or coupled to the hose.

As noted above, in various embodiments, the change in length may be from 1.2 to 4 times. In exemplary embodiments, the change in length may be in the range of approximately 1.8 to 2.5 times.

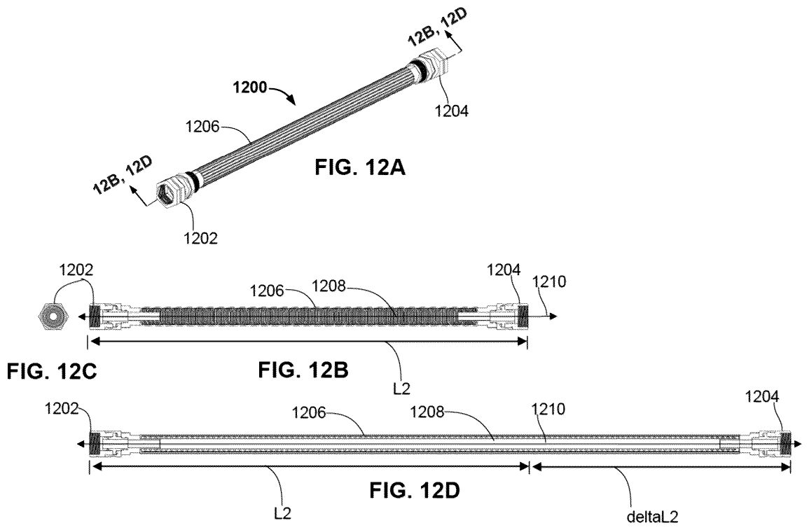

FIGS. 12A, 12B, 12C, and 12D depict views an embodiment of an expandable hose 1200 according to an exemplary embodiment. The expandable hose 1200 has a first connector 1202 and a second connector 1204. The first and second connectors of this embodiment may both be female type threaded connectors. The expandable hose has an outer layer 1206 and an inner duct 1208. The expandable hose 1200 may lack the sheath surrounding the inner duct 1208. That is, the structure of this embodiment may have the inner duct 1208 and the outer layer 1206 with no sheath in between. The inner duct 1208 is not connected to the outer layer 1206. The inner duct 1208 and the outer layer 1206 both terminate at the first and second connectors as shown in the figures and as described above. The construction of the inner duct and the outer layer, as well as the connectors, may be as described above with respect to the various embodiments.

The expandable hose 1200 has an exemplary fluid flow path 1210 that can go either way (e.g., from the first connector to the second connector or vice versa).

As depicted in FIG. 12B, the expandable hose 1200 has a length L2 which is the length of the expandable hose in its unused state or resting state (e.g., this is the length when the hose is bought off the shelf). The inner duct 1108 may be in the relaxed state. As depicted in FIG. 12D, the expandable hose may be under pressure and elongated to a length of L2+deltaL2. The inner duct 1208 may be in the expanded state. The outer layer 1206 may also expand in response the change in the inner duct 1208. The expansion and contraction of the expandable hose may be as described above with respect to the increase and decrease of fluid pressure with the expandable hose.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above described embodiments, method, and examples, but by all embodiments within the scope and spirit of the invention as claimed.

Further, it is to be understood that the terminology used herein is for the purpose of describing particular embodiments only and is not intended to be limiting. The terms “a” or “an” as used herein, are defined as one or more than one.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

1. An expandable hose, comprising:
an inner duct comprising a corrugated, flexible material that comprises a series of continuous and alternating peaks and valleys when in a contracted state and is configured to expand and contract in an accordion-like manner;
an outer layer comprising an elastic fabric material;
a first end having a first connector and a first termination point for the inner duct and the outer layer; and
a second end having a second connector and a second termination point for the inner duct and the outer layer;
wherein the inner duct provides a fluid flow path between the first end and the second end through each of the first connector and the second connector and the corrugated, flexible material of the inner duct is configured to allow for expansion of the inner duct in response to an increase in fluid pressure in the inner duct; and
wherein the outer layer is configured to elongate in response to the expansion of the inner duct and the outer layer is further configured to contract upon a decrease in fluid pressure, causing the inner duct to contract in response.

2. The expandable hose of claim 1, wherein the corrugated, flexible material is comprised of polyvinyl chloride (PVC), polyurethane (PU), plastic reinforced with steel wire, or combinations thereof.

3. The expandable hose of claim 1, wherein the elastic fabric material comprises polyester, nylon, cotton, or combinations thereof.

4. The expandable hose of claim 1, further comprising:
a connection component that couples the inner duct and the outer layer and is located between the first end and the second end.

5. The expandable hose of claim 4, wherein the connection component serves as an intermediate termination point for the inner duct and the outer layer, dividing the inner duct and the outer layer into a first segment extending from the first termination point to the connection component and a second segment extending from an opposite side of the connection component to the second termination point.

6. The expandable hose of claim 4, wherein the connection component is comprised of plastic, metal, or combinations thereof.

7. The expandable hose of claim 1, wherein the first connector is a male threaded connector and the second connector is a female threaded connector.

8. The expandable hose of claim 1, wherein an overall length of the expandable hose increases upon expansion of the inner duct.

9. The expandable hose of claim 1, further comprising:
a continuous sheath, surrounding the inner duct, and located between the inner duct and the outer layer and terminating at the first and second termination points, and that is configured to assist with contraction of the inner duct, and the continuous sheath is connected to the inner duct between the first and second termination points and is not connected to the outer layer between the first and second termination points.

10. The expandable hose of claim 9, wherein the continuous sheath is comprised of rubber, latex, or combinations thereof.

11. An expandable hose, comprising:
an inner duct comprising a corrugated, flexible material comprising a series of continuous and alternating peaks and valleys in a contracted state and is configured to expand and contract in an accordion-like manner;
an outer layer comprising an elastic fabric material;
a first end having a first connector, a first termination point for the inner duct and the outer layer, and a valve located between the first connector and the first termination point; and
a second end having a second connector and a second termination point for the inner duct and the outer layer;
wherein the inner duct provides a fluid flow path between the first end and the second end through each of the first connector and the second connector and the corrugated, flexible material of the inner duct is configured to allow for expansion of the inner duct in response to an increase in fluid pressure in the inner duct; and
wherein the outer layer is configured to elongate in response to the expansion of the inner duct and the outer layer is further configured to contract upon a decrease in fluid pressure, causing the inner duct to contract in response.

12. The expandable hose of claim 11, wherein the corrugated, flexible material is comprised of polyvinyl chloride (PVC), polyurethane (PU), plastic reinforced with steel wire, or combinations thereof.

13. The expandable hose of claim 11, wherein the elastic fabric material comprises polyester, nylon, cotton, or combinations thereof.

14. The expandable hose of claim 11, wherein the first connector is a male threaded connector and the second connector is a female threaded connector.

15. The expandable hose of claim 11, wherein valve comprises a ball valve.

16. The expandable hose of claim 11, wherein an overall length of the expandable hose increases upon expansion of the inner duct.

17. The expandable hose of claim 11, further comprising:
a continuous sheath, surrounding the inner duct, and located between the inner duct and the outer layer and terminating at the first and second termination points, and that is also configured to assist with contraction of the inner duct, and the continuous sheath is connected to the inner duct between the first and second termination points and is not connected to the outer layer between the first and second termination points.

18. The expandable hose of claim 17, wherein the continuous sheath is comprised of rubber, latex, or combinations thereof.

19. An expandable hose, comprising:
an inner duct comprising a corrugated, flexible material comprising a series of continuous and alternating peaks and valleys in a contracted state and is configured to expand and contract in an accordion-like manner;
an outer layer comprising an elastic fabric material;
a sheath, surrounding the inner duct and located between the inner duct and the outer layer;
a first end having a first connector and a first termination point for the inner duct, the sheath, and the outer layer;
a second end having a second connector and a second termination point for the inner duct, the sheath, and the outer layer; and
wherein the sheath is continuous between the first and second termination points and is connected to the inner duct between the first and second termination points and is not connected to the outer layer between the first and second termination points;
wherein the inner duct provides a fluid flow path between the first end and the second end through each of the first connector and the second connector and the corrugated, flexible material of the inner duct is configured to allow for expansion of the inner duct in response to an increase in fluid pressure in the inner duct; and
wherein the outer layer is configured to elongate in response to the expansion of the inner duct and the outer layer is further configured to contract upon a decrease in fluid pressure, causing the inner duct to contract in response, and wherein further the sheath is configured to assist with the contraction of the inner duct.
